(19) United States
(12) Patent Application Publication
(10) Pub. No.: US 2007/0189121 A1
(43) Pub. Date: Aug. 16, 2007

(54) Device and method for simultaneously displaying the time in different time zones

(76) Inventors: Eduardo Antonio Assuncao, Delray Beach, FL (US); Cristiane Rocha Assuncao, Delray Beach, FL (US)

Correspondence Address: RUDEN, MCCLOSKY, SMITH, SCHUSTER & RUSSELL, P.A., 222 LAKEVIEW AVE, SUITE 800, WEST PALM BEACH, FL, 33401-6112, US

(21) Appl. No.: 11/355,435

(22) Filed: Feb. 16, 2006

(51) Int. Cl. G04B 19/22

(52) U.S. Cl. 368/21

(57) ABSTRACT

A device having at least a first clock and a second clock and a map of a geographical area depicting at least a first time zone and a second time zone, the first clock being positioned proximate to the first time zone and the second clock being positioned proximate to the second time zone; and a method of using the device to simultaneously determine the time in at least the first and second time zones.

### FIELD OF THE INVENTION

The invention relates to a device and method for simultaneously determining the time in at least two different time zones. More particularly, the invention relates to a device having at least a first clock and a second clock and a map of a geographical area depicting at least a first time zone and a second time zone, the first clock being positioned proximate to the first time zone and the second clock being positioned proximate to the second time zone; and a method of using the device to simultaneously determine the time in at least the first and second time zones.

### BACKGROUND

Over-the-road truckers, airline personnel, and others who frequently travel between distant geographical areas often have a need to know the time in two or more time zones. This is typically achieved by a person calculating the time in a first time zone by determining the time in that zone and then adding or subtracting the number of hours to or from that time in accordance with how many time zones are between the first and second time zones. Because a mental calculation is involved in this method, it can be inconvenient, slow, and susceptible to human error.

Devices for automating this calculation have been developed to overcome the foregoing issues. For example, wristwatches that simultaneously display the time in more than one time zone are known. While these devices are convenient, they are less than optimal for travelers such as over-the-road truck drivers who move through more than two different time zones during a single trip. For such travelers, what is needed is a device that simultaneously displays the time in multiple time zones in such a manner that time in any of the multiple time zones can be determined with minimal mental effort. Such an easy-to-use device would be especially useful for travelers operating a motor vehicle, particularly over-the-road truck drivers who need to maintain their attention on the road.

### SUMMARY

The invention relates to the development of a device that allows a user to easily and readily determine the time in multiple time zones without requiring significant mental effort. The device is advantageous for motor vehicle operators who travel across multiple time zones and have a need to know the time in at least one of the time zones.

Accordingly, the invention features a device having mounted thereon both a plurality of clocks including at least a first and second clock, and a map of a geographical area depicting a plurality of time zones including at least the first and second time zones. In the device, the first clock is positioned proximate to the first time zone and the second clock is positioned proximate to the second time zone.

In one variation, the first clock is positioned on the device directly above the first time zone and the second clock is positioned on the device directly above the second time zone. In another variation, the first clock is positioned on the device directly below the first time zone and the second clock is positioned on the device directly below the second time zone.

In the device, the geographical area can include the continental 48 states of the United States of America, the plurality of clocks mounted on the device can further include at least a third clock and a fourth clock; and the plurality of time zones can include four time zones: the Pacific time zone, the Mountain time zone, the Central time zone, and the Eastern time zone.

In one embodiment of the device, the first clock is mounted to the device within a first clock mounting area of the device and the second clock is mounted to the device within a second clock mounting area of the device, and the first time zone, the first clock mounting area, and/or the first clock are marked with a first discernible identifier and the second time zone, second clock mounting area and/or the second clock are marked with a second discernible identifier differing from the first discernible identifier. The discernible identifiers might be shades, colors, and/or alphanumeric characters.

The device might also include a front portion including the plurality of clocks and the map of the geographical area; and a back portion including a fastener (e.g., an adhesive, a mechanical connector, and a hook and loop type connector) for affixing the device to the dashboard of a motor vehicle.

In some variations, the device further includes a base portion (e.g., including a non-slip material) for supporting the device on a horizontal surface such as a desktop.

The front portion can be substantially planar or non-planar, and at least one of the plurality of clocks might be analog, digital, reversibly removable from the device, and/or battery-operated.

In another aspect, the invention features a device for simultaneously displaying the time in at least a first time zone, a second time zone, a third time zone, and a fourth time zone. This device includes a plurality of clocks mounted on the device, the plurality of clocks including at least a first clock, a second clock, a third clock and a fourth clock; and a map including the continental 48 states of the United States of America mounted on the device, the map depicting a plurality of time zones, the plurality of time zones including at least the first time zone, the second time zone, the third time zone, and the fourth time zone. In this device, the first clock is positioned proximate to the first time zone, the second clock is positioned proximate to the second time zone, the third clock is positioned proximate to the third time zone, and the fourth clock is positioned proximate to the fourth time zone, and the first time zone is the Pacific time zone, the second time zone is the Mountain time zone, the third time zone is the Central time zone, and the fourth time zone is the Eastern time zone.

The invention further features a method for determining the time in a different time zone. The method includes the steps of:(a) providing a device in a first time zone, the device including a plurality of clocks mounted on the device, the plurality of clocks including at least a first clock and a second clock; and a map of a geographical area mounted on the device, the map depicting a plurality of time zones, the plurality of time zones including at least the first time zone and a second time zone, wherein the first clock is positioned proximate to the first time zone and the second clock is positioned proximate to the second time zone; and (b) determining the time on the second clock.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a front perspective view of a dashboard mountable device of the invention.

FIG. 2 is a back perspective view of a dashboard mountable device of the invention.

FIG. 3 is a front perspective view of a desktop device of the invention with a planar front portion.

FIG. 4 is a front perspective view of a desktop device of the invention with a non-planar front portion.

### DETAILED DESCRIPTION

The invention encompasses various devices and methods that facilitate determining the time in a particular time zone among a multitude of contiguous time zones. The below described preferred embodiments illustrate adaptations of these devices and methods. Nonetheless, from the description of these embodiments, other aspects of the invention can be made and/or practiced based on the description provided below.

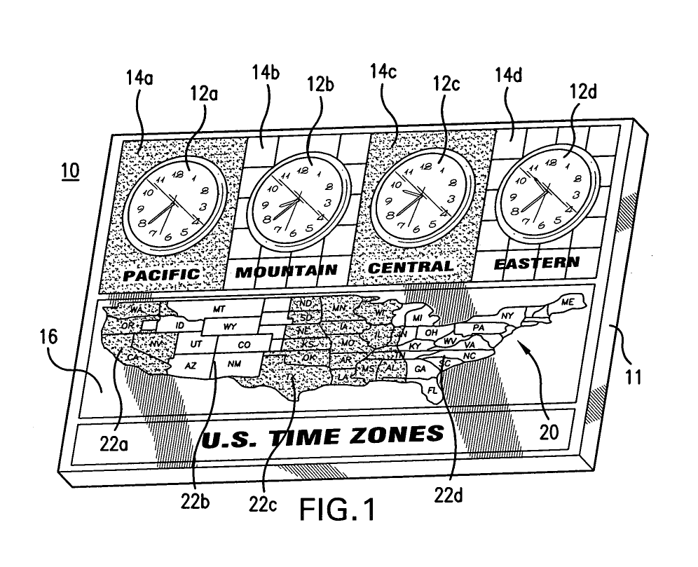

Referring to FIG. 1, a device 10 adapted for mounting to a flat surface such as a dashboard or a wall, and capable of simultaneously displaying the time in at least a first time zone and a second time zone includes a housing 11, four clocks 12a-d, four clock mounting areas 14a-d, and a map 20 divided into four time zones 22a-d. The housing 11 includes a front portion 16 and a back portion 18. It can take any suitable form and may be made of any material capable of supporting the clocks 12a-d and the map 20. Preferably, the housing is made of a rigid material such as a plastic, wood, or metal and is shaped and sized to be affixed to the dashboard of a truck (e.g., its largest side being less than about 100, 90, 80, 70, 60, 50, 40, 30, 20 or 10 square inches).

The front portion 16 features four clock mounting areas 14a-d into which four clocks 12a-d are placed. The clocks 12a-d shown are battery-operated, round, analog clocks, but might take the form of any suitable time display device, e.g., a clock with a digital (LED, LCD) display. Also on the housing 11 is a map of a geographical area 20. In the embodiment shown, the map 20 is of the continental United States that depicts its four time zones 22a-d. Each of the clocks 12 is positioned proximate to the corresponding time zones 22.

In FIG. 1, the first (Pacific) time zone 22a is positioned just below the first clock 12a; the second (Mountain) time zone 22b is positioned just below the second clock 12b; the third (Central) time zone 22b is positioned just below the third clock 12c; and the fourth (Eastern) time zone 22d is positioned just below the fourth clock 12d. Each of the clock mounting areas 14a-d has printed thereon the name of the corresponding time zone (i.e., Pacific, Mountain, Central, and Eastern).

The device 10 might also feature maps of any geographical area of the work that includes more than one time zone. For example, the device 10 might include a map of Canada, North America, South America, Europe, Africa, Asia, or Australia.

In the device 10 shown in FIG. 1, both the four clock mounting areas 14a-d and the four time zones 22a-d are marked with discernible identifiers for correlating a particular clock 12 with a particular time zone 22. Discernible identifiers useful in the invention include any detectable thing that can be used to identify and distinguish one item from another. Examples of discernible identifiers include colors, shapes, tints, hues, shades, alphanumeric characters (e.g., words), symbols, textures, or combinations of the foregoing. In the embodiment of FIG. 1, for example, clock mounting area 14a and Pacific time zone 22a are marked with the same dark shade, while clock mounting area 14b and Mountain time zone 22b are marked with a lighter shade. Also in this embodiment, the Pacific and Central time zones 22a and 22c and the corresponding clock mounting areas 14a and 14c are each marked with the identical darker shade; and the Mountain and Eastern time zones 22b and 22d and the corresponding clock mounting areas 14b and 14d are each marked with the identical lighter shade. Because the darker shade and lighter shade are alternated, it is easy for a user of the device 10 to discern which clock corresponds to which time zone. In one alternate embodiment, each different time zone and corresponding clock mounting area is marked with different discernible identifiers. In another alternate embodiment, the clocks themselves, rather than or in addition to the clock mounting areas, are marked with discernible identifiers.

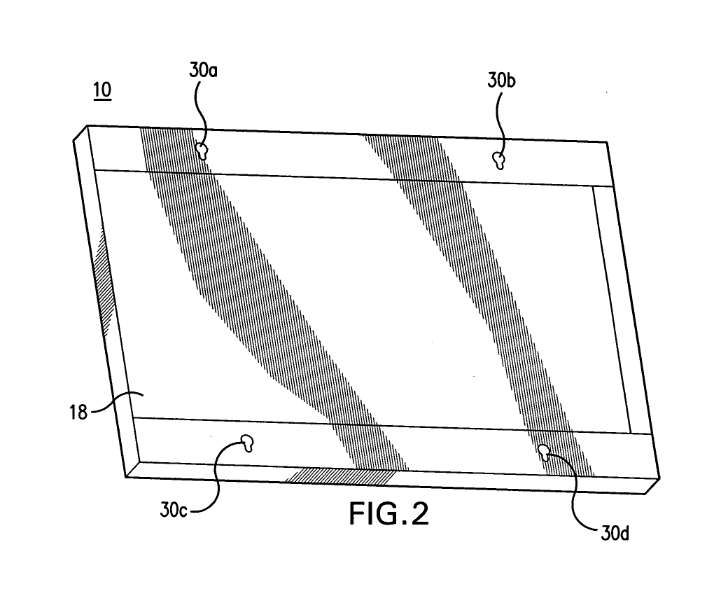

Referring to FIG. 2, the back portion 18 of housing 11 also includes a fastener 30 for attaching the device 10 to a flat surface such as a motor vehicle dashboard or a wall. In the embodiment shown the fastener 30 is shown as four holes 30a-30d which are able to engage protrusions from the flat surface to which the device 10 is to be affixed. In other embodiments, the fastener 30 might take the form of any device or system suitable for reversibly or irreversibly joining the device 10 to a surface, e.g., an adhesive tape (e.g., a repositionable adhesive), a magnet, or a mechanical connector such as a hook and loop-type connector.

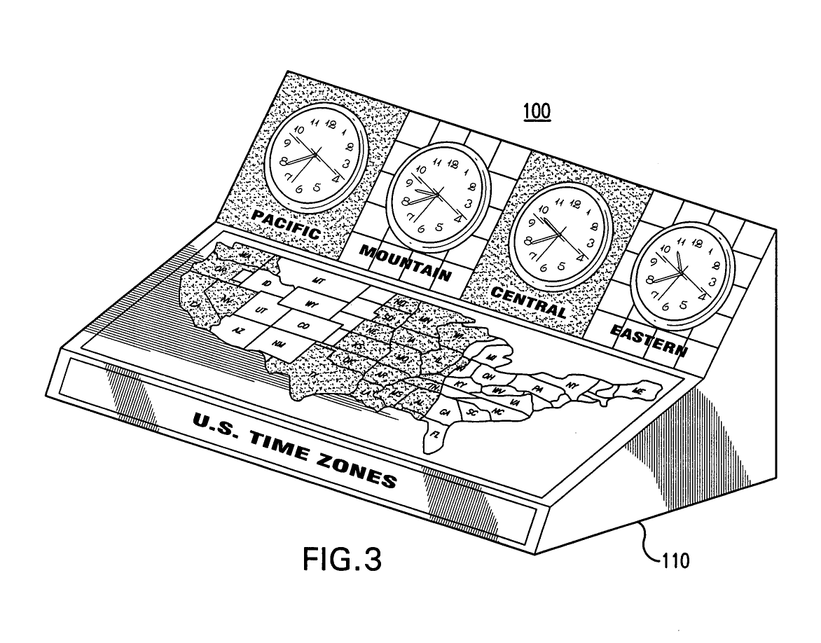

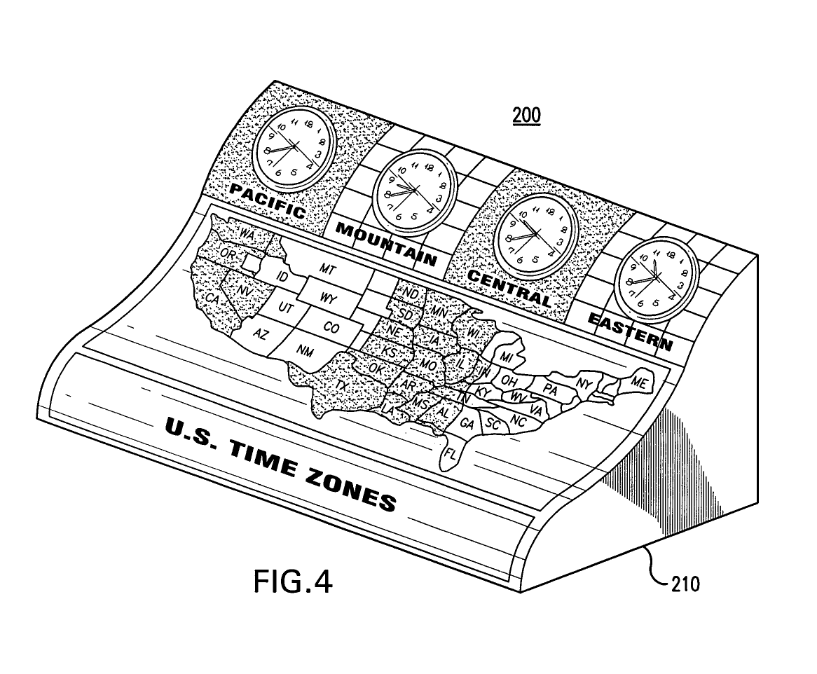

Referring to FIGS. 3 and 4, the devices of the invention are not limited to those suitable for attachment to a surface such as a wall or dashboard. For example, the devices 100 and 200 are variations of embodiments suitable for placement on a desktop, countertop, or other horizontal surface with or without a means for affixing the devices 100 and 200 to the surface. In preferred arrangements, the devices 100 and 200 include bases 110 and 210 (e.g., including a non-slip surface) for engaging the horizontal surface. The device 100 of FIG. 3 features a planar (i.e., made up of one or more flat surfaces lacking any substantial curvature) front, while the device 200 of FIG. 4 features a non-planar (curved) front.

The devices described herein may be manufactured from conventional materials and components by conventional techniques.

The devices of the invention are simple to use. In the embodiments shown in FIGS. 1-3, for example, a person located in one time zone wishing to know the time in that or a different time zone located on the map on the device, simply reads the clock located proximate to appropriate time zone depicted on the map on the device. In those variations of the devices including discernible identifiers on the time zones depicted on the map and the corresponding clocks or clock mounting areas, a user might use these discernible identifiers to help correlate the correct clock for a given time zone.

### Other Embodiments

It is to be understood that while the invention has been described in conjunction with the detailed description thereof, the foregoing description is intended to illustrate and not limit the scope of the invention, which is defined by the scope of the appended claims. For example, devices within the invention might include one or more self-setting clocks (e.g., radio-controlled to synchronize with the U.S. atomic clock), a clock that luminesces for easier nighttime viewing, an integrated global positioning system (e.g., with an indicator of the device's position on the map), and/or a compass. Other aspects, advantages, and modifications are within the scope of the following claims.

What is claimed is:

1. A device for simultaneously displaying the time in at least a first time zone and a second time zone, the device comprising:
a plurality of clocks mounted on the device, the plurality of clocks comprising at least a first clock and a second clock; and
a map of a geographical area mounted on the device, the map depicting a plurality of time zones, the plurality of time zones comprising at least the first time zone and the second time zone;
wherein the first clock is positioned proximate to the first time zone and the second clock is positioned proximate to the second time zone.

2. The device of claim 1, wherein the first clock is positioned on the device directly above the first time zone and the second clock is positioned on the device directly above the second time zone.

3. The device of claim 1, wherein the first clock is positioned on the device directly below the first time zone and the second clock is positioned on the device directly below the second time zone.

4. The device of claim 1, wherein the geographical area comprises the continental 48 states of the United States of America;
the plurality of clocks mounted on the device further comprises at least a third clock and a fourth clock;
the plurality of time zones further comprises at least a third time zone and a fourth time zone; and
the first time zone is the Pacific time zone, the second time zone is the Mountain time zone, the third time zone is the Central time zone, and the fourth time zone is the Eastern time zone.

5. The device of claim 1, wherein the first clock is mounted to the device within a first clock mounting area of the device and the second clock is mounted to the device within a second clock mounting area of the device and the first time zone and the first clock mounting area are marked with a first discernible identifier and the second time zone and second clock mounting area are marked with a second discernible identifier differing from the first discernible identifier.

6. The device of claim 1, wherein the first clock is mounted to the device within a first clock mounting area of the device and the second clock is mounted to the device within a second clock mounting area of the device and the first time zone and the first clock are marked with a first discernible identifier and the second time zone and second clock are marked with a second discernible identifier differing from the first discernible identifier.

7. The device of claims 5 or 6, wherein the first and second discernible identifiers are selected from the group consisting of: shades, colors, and alphanumeric characters.

8. The device of claim 1, wherein the device comprises a front portion comprising the plurality of clocks and the map of the geographical area; and a back portion comprising a fastener for affixing the device to the dashboard of a motor vehicle.

9. The device of claim 8, wherein the fastener is selected from the group consisting of an adhesive, a mechanical connector, and a hook and loop type connector.

10. The device of claim 1, wherein the device comprises a front portion comprising the plurality of clocks and the map of the geographical area; a back portion; and a base portion for supporting the device on a horizontal surface.

11. The device of claim 10, wherein the base portion comprises a non-slip material.

12. The device of claim 10, wherein the front portion is substantially planar.

13. The device of claim 10, wherein the front portion is non-planar.

14. The device of claim 1, wherein at least one of the plurality of clocks is an analog clock.

15. The device of claim 1, wherein at least one of the plurality of clocks is a digital clock.

16. The device of claim 1, wherein at least one of the plurality of clocks is a battery-operated clock.

17. The device of claim 1, wherein at least one of the plurality of clocks is reversibly mounted to the device.

18. A device for simultaneously displaying the time in at least a first time zone, a second time zone, a third time zone, and a fourth time zone, the device comprising:
a plurality of clocks mounted on the device, the plurality of clocks comprising at least a first clock, a second clock, a third clock and a fourth clock; and
a map comprising the continental 48 states of the United States of America mounted on the device, the map depicting a plurality of time zones, the plurality of time zones comprising at least the first time zone, the second time zone, the third time zone, and the fourth time zone;
wherein the first clock is positioned proximate to the first time zone, the second clock is positioned proximate to the second time zone, the third clock is positioned proximate to the third time zone, and the fourth clock is positioned proximate to the fourth time zone, and
wherein the first time zone is the Pacific time zone, the second time zone is the Mountain time zone, the third time zone is the Central time zone, and the fourth time zone is the Eastern time zone.

19. The device of claim 18, wherein the first clock is mounted to the device within a first clock mounting area of the device and the second clock is mounted to the device within a second clock mounting area of the device and the first time zone and the first clock mounting area are marked with a first discernible identifier and the second time zone and second clock mounting area are marked with a second discernible identifier differing from the first discernible identifier.

20. A method for determining the time in a different time zone, the method comprising the steps of:
(a) providing a device in a first time zone, the device comprising a plurality of clocks mounted on the device, the plurality of clocks comprising at least a first clock and a second clock; and a map of a geographical area mounted on the device, the map depicting a plurality of time zones, the plurality of time zones comprising at least the first time zone and a second time zone, wherein the first clock is positioned proximate to the first time zone and the second clock is positioned proximate to the second time zone; and
(b) determining the time on the second clock.
